(19) United States
(12) Patent Application Publication
(10) Pub. No.: US 2025/0220312 A1
(43) Pub. Date: Jul. 3, 2025

(54) METHOD FOR CORRECTING OPTICAL ABERRATIONS INTRODUCED BY AN OPTICAL LENS IN AN IMAGE, APPARATUS AND SYSTEM IMPLEMENTING SUCH A METHOD

(71) Applicant: FOGALE NANOTECH, Nîmes (FR)

(72) Inventors: Eric LEGROS, Nîmes (FR); Sylvain PETITGRAND, Caissargues (FR)

(21) Appl. No.: 18/850,454

(22) PCT Filed: Mar. 31, 2023
(86) PCT No.: PCT/EP2023/058490

§ 371 Date: Sep. 24, 2024

(30) Foreign Application Priority Data
Apr. 1, 2022 (FR) FR2202987

(51) Int. Cl. H04N 23/81; H04N 23/55

(52) U.S. Cl. CPC H04N 23/81; H04N 23/55

(57) ABSTRACT

A method for acquiring an image with an apparatus including a camera module including an optical lens associated with an image sensor, the method including at least one iteration of an image acquisition phase by the apparatus including the following steps:
capturing an image with the camera module; and
correcting the captured image according to at least one correction matrix calculated, directly or indirectly, from at least one matrix, referred to as aberration matrix, determined for the optical lens, and representative of optical aberrations introduced by the optical lens in an image. Also disclosed are a characterization system and an imaging apparatus implementing such a method.

The present invention concerns a method for correcting optical aberrations introduced by an optical lens into an image captured with said optical lens. It likewise relates to a system and apparatus implementing such a method.

The field of the invention is the field of correcting images captured with an optical lens, with a view to correcting optical aberrations caused by said optical lens.

### PRIOR ART

Optical lenses are used in a variety of apparatuses, such as still and video cameras, smartphones, etc., to capture an image of a scene.

Typically, an optical lens consists of a stack of optical elements, such as optical lenses, separated by an air gap or spacer. They are generally assembled via a device known as a barrel.

To produce an image, the optical lens cooperates with a photosensitive sensor, such as a CMOS or CCD sensor. The medium plane of the image sensor is called the image plane, and the sensor comprises a multitude of pixels. The assembly comprising the optical lens and the image sensor is generally referred to as an “optical module” or “camera module”.

The trend towards miniaturization of camera modules used in electronic devices such as smartphones is reducing component manufacturing tolerances, particularly for optical lenses. Manufacturing defects can thus appear in the form of image defects on the image sensor. For example, optical aberrations can result in blurred images. The brightness of a pixel in an original image is distorted, modifying the brightness of an adjacent pixel in the captured image.

One aim of the present invention is to solve at least one of the above-mentioned shortcomings.

Another aim of the invention is to offer a solution that provides correction of optical aberrations introduced by an optical lens in an image captured by said lens.

### DISCLOSURE OF THE INVENTION

The invention proposes to achieve at least one of the aforementioned goals by an image acquisition method with an apparatus comprising a camera module that comprises an optical lens associated with an image sensor, said method comprising at least one iteration of an image acquisition phase by said apparatus comprising the following steps:
capturing an image with said camera module; and
correcting said captured image based on at least one correction matrix calculated, directly or indirectly, from at least one matrix, called aberration matrix, determined for said optical lens, and representative of optical aberrations introduced by said optical lens into an image.

Thus, the invention proposes to correct an image captured with an optical lens within the device itself which comprises said optical lens. In this way, image correction can be adapted to each apparatus individually, and can be carried out on the fly as the apparatus takes the image. The solution proposed by the present invention is therefore more customizable and scalable.

To achieve this, the invention proposes the use of a correction matrix calculated based on at least one aberration matrix previously determined for the optical lens used. The correction matrix can be determined directly from the aberration matrix, or indirectly, for example from a previously calculated aberration kernel matrix or correction kernel matrix, as described below.

“Optical aberration” refers in particular to optical blurring or distortion. Optical blurring generally means the spreading of a point of light. Distortion generally means a shift in the optical point.

The optical elements making up an optical lens are stacked along a stacking direction, also hereafter referred to as the Z axis, or the optical lens axis. The plane perpendicular to the Z axis, i.e. the plane along which each optical element extends, is hereafter referred to as the X-Y plane.

By “geometric parameter of an optical interface”, it is meant, for example, and without loss of generality:
a position of the optical interface within the lens, in the Z axis;
a position of an APEX of the optical interface, in particular in the X-Y plane and/or
a position of an APEX of the optical interface, in particular along the Z axis,
an inclination (TIP and/or TILT) of said optical interface with respect to the Z axis,
a decentration of an optical interface, or an optical element, from the Z axis in the X-Y plane.

In the present application, “buried optical interface” of an optical lens means an interface within the optical lens that is only visible, or accessible, via at least one other optical interface of the lens. The at least one other optical interface through which the buried interface is visible may be an optical interface of the same optical element, or an optical interface of an optical element other than the buried interface.

“Pixel” means an elementary pattern of an image comprising, for example, color values R, G, B, or luminance and chrominance, that is, an element that forms a “point” of an image.

In the present document, a region of the image sensor centered on the coordinates (Xᵢ, Yᵢ), in the (X,Y) plane, can be referred to as R(Xᵢ, Yᵢ), or Rᵢ.

In this document, MA refers to the aberration matrix for the entire optical lens. MAᵢ, or MAᵢ (Xᵢ, Yᵢ) designates the aberration matrix for the region Rᵢ of the lens. The aberration matrix MA can be obtained by concatenating or adding the aberration matrices MAᵢ for all regions of the image sensor.

The, or each, correction matrix is designated by the letters MC.

The image sensor can be any type of photosensitive sensor, such as a CMOS or CCD sensor, etc.

In particularly advantageous embodiments, the image acquisition phase may comprise a step for determining a lens-sensor distance, or LSD, between the optical lens and the image sensor, the at least one correction matrix being a function of said LSD distance.

Thus, the method according to the invention makes it possible to take into account the optical aberrations introduced by the optical lens into an image, when the distance between the optical lens and the image plane, that is, the plane of the image sensor, is changing, and to correct these aberrations with correction matrices determined as a function of this LSD distance. Indeed, the inventors have noticed that, for a given lens, the optical aberrations introduced by said lens can vary as a function of the distance between said lens and the image plane.

The image plane can be the plane of the image sensor.

Thus, for each distance LSDⱼ, with j≥2, an aberration matrix MAⱼ corresponding to the entire image sensor can be determined. Alternatively, for each distance LSDⱼ, a plurality of MAᵢⱼ aberration matrices can be determined for each region of the image sensor. The aberration matric MAⱼ. or each aberration matrix MAᵢⱼ, can then be used to directly or indirectly derive a correction matrix MCⱼ for the entire sensor, or correction matrices MCᵢⱼ for each region Rᵢ of the image sensor.

The, or each, LSD distance can, for example, be measured by a distance sensor, such as an optical sensor, a magnetic sensor, a capacitive sensor, etc.

The, or each, LSD distance can, for example, be calculated from information provided by a focus adjustment mechanism modifying or controlling the distance between the optical lens and the image sensor.

In particularly advantageous embodiments, the image acquisition phase may comprise a step for determining an optical distance, OD, between the optical lens and the scene, the at least one correction matrix being a function of said OD distance.

Thus, the method according to the invention makes it possible to take into account the optical aberrations introduced by the optical lens into an image, when the distance between the optical lens and the image scene is changing. Indeed, the inventors have noticed that, for a given lens, the optical aberrations introduced by said optical lens can vary as a function of the distance between said lens and the scene, or each part of the scene.

Thus, for each distance ODₖ, with k≥2, an aberration matrix MAₖ corresponding to the entire image sensor can be determined. Alternatively, for each distance ODₖ, multiple aberration matrices MAᵢₖ can be determined for each region of the image sensor. The aberration matrix MAₖ, or each aberration matrix MAᵢₖ, can then be used to directly or indirectly derive a correction matrix MCₖ for the entire sensor, or correction matrices MCᵢₖ for each region Rᵢ of the image sensor.

The, or each, OD distance can, for example, be measured by LIDAR, a time-of-flight camera, an ultrasonic sensor, textured image analysis and so on.

A single OD distance can be measured for the optical lens. Alternatively, several OD distances can be measured for different regions Rᵢ of the optical sensor, for the same given scene. This is because an imaged scene may comprise multiple objects at different OD distances. In this case, a distance ODᵢₖ is determined for each region Rᵢ of the sensor, and the correction matrix is selected individually for each region Rᵢ as a function of the ODᵢₖ distance measured for that region Rᵢ of the sensor.

According to some embodiments, an image can be corrected according to a plurality of correction matrices, each selected based on:
a region Rᵢ of the image sensor,
the distance LSDⱼ between the image sensor and lens, and
the distance ODₖ between the optical lens and the scene in said region Rᵢ.

This correction matrix can be denoted MCᵢⱼₖ.

This involves determining, for each region Rᵢ of the sensor, multiple aberration matrices MAᵢⱼₖ each corresponding to a distance LSDⱼ, and to a distance ODₖ in said region Rᵢ, where:
i=1, . . . , l and I≥2,
j=1, . . . , J and J≥2
k=1, . . . , K and K≥2

For example, by taking ten (10) image sensor regions, 3 distances LSDⱼ, and 5 distances ODₖ for each region of the image sensor, 15 aberration matrices can be determined for each region of the image sensor, and a total of 150 aberration matrices for the optical lens.

In the following, for the sensor region Rᵢ, the distance LSDⱼ and the distance ODₖ:
MAᵢⱼₖ is the aberration matrix, and
MCᵢⱼₖ is the correction matrix.

Of course, if the LSD distance and/or the OD distance are not variable, then the notations MAᵢⱼₖ and MCᵢⱼₖ do not necessarily imply that these distances are variable.

According to embodiments, the method according to the invention may comprise a step of calculating the at least one correction matrix outside the imaging apparatus. In this case, the correction matrix can in some cases be stored inside said imaging apparatus.

Alternatively, the method according to the invention may comprise a step for calculating the at least one correction matrix within said apparatus.

In this case, the calculation of the correction matrix used for image correction is performed by a calculating unit of the imaging apparatus.

In one embodiment, the step of calculating the at least one correction matrix can be carried out during the acquisition phase, so that the at least one correction matrix is calculated on the fly for each captured image.

Thus, for each image acquisition, the at least one correction matrix is calculated taking into account the conditions under which the image is acquired, so that the image correction is customized for each image. The image correction is therefore more precise. Furthermore, in this embodiment, it is possible to calculate only the correction matrices used to correct the acquired image. For example, it is possible to calculate only the correction matrices for the LSD distance, and/or the OD distance(s) determined for this image.

In one embodiment, the step of calculating the at least one correction matrix can be performed prior to the acquisition phase, so that said calculation step is common to multiple iterations of the image acquisition phase.

In this case, image correction can be carried out more quickly, as it is not necessary to calculate the at least one correction matrix on the fly. In this embodiment, all the correction matrices corresponding to the configurations, and in particular the LSD and OD distances likely to be used for the images to be corrected, can be calculated and stored within the device in a database. Then, at each iteration of the acquisition phase, the at least one correction matrix corresponding to the image acquisition configuration during this acquisition phase can be selected, in particular as a function of the LSD distance and/or the at least one OD distance, to perform the correction of the image acquired during said acquisition phase.

At least one correction matrix can be calculated from at least one aberration matrix.

In particular, each correction matrix can be calculated from an aberration matrix. For example, the correction matrix MCᵢⱼₖ can be calculated from the aberration matrix MAᵢⱼₖ.

At least one correction matrix can be calculated by inverting the corresponding aberration matrix, for example using calculations in the spatial frequency domain.

According to exemplary embodiments, at least one correction matrix can be obtained by the relationship:

$$M {C}_{i j k} = T {F}^{- 1} \{ \frac{T F \{ {G}_{0} \}}{T F \{ M {A}_{i j k} \}} \}$$

where G₀ is a function representing the form of the point dispersion function to be obtained after correction. It can be a function approaching a Dirac function in two dimensions, that is, 1 at the center, and almost 0 around it. Using MTOBSᵢⱼₖ to refer to the matrix of a test light beam as observed for measuring an aberration matrix, and MT its native form as it actually is when emitted, the correction matrix MCᵢⱼₖ can be calculated as follows:

$$M {C}_{i j k} = T {F}^{- 1} \{ \frac{T F \{ {G}_{0} \} \cdot TF \{ {MT}_{i j k} \}}{T F \{ {MTOBS}_{i j k} \}} \}$$

In simplified form, it is possible to assume that TF(G0)=1, the constant function that returns 1 with zero phase at all frequencies, which leads to:

$$M {C}_{i j k} = T {F}^{- 1} \{ \frac{T F \{ M {T}_{i j k} \}}{T F \{ {MTOBS}_{i j k} \}} \}$$

where:
TF is the Fourier transform operator (in 2D);
TF⁻¹ is the inverse Fourier transform operator (in 2D);
MCᵢⱼₖ is the correction matrix for the Rᵢ region of the image sensor, at lens-to-sensor distance LSDⱼ and object distance ODₖ for said region Rᵢ;
MAᵢⱼₖ is the aberration matrix obtained for the region Rᵢ of the image sensor and the distances LSDᵢ and ODₖ; and
MTᵢⱼₖ is the test light beam matrix, that is, the matrix describing the test light beam, used to measure the aberration matrix MAᵢⱼₖ; and
MTOBSᵢⱼₖ is the observed illumination matrix in the sensor plane with respect to the test matrix MTᵢⱼₖ presented at the input of the optical lens.

At least one correction matrix can be calculated from at least one previously calculated aberration kernel matrix, comprising coefficients for deducing said at least one aberration matrix.

The use of an aberration kernel matrix avoids the need to store all the aberration matrices used to determine the correction matrices, and therefore reduces the memory space used to store the aberration matrices.

In this case, multiple aberration matrices can be determined, prior to the correction phase. Then, from these matrices, a common matrix can be identified. This common matrix, called aberration kernel matrix, can be stored instead of the multitude of aberration matrices, in relation to one or more relationships, to enable the calculation of each aberration matrix, which can then be used to determine a correction matrix as will be described below.

The kernel aberration matrix can, according to an embodiment example by no means restrictive, be determined from aberration matrices as follows.

As a first step, a basis of FA functions may be established to describe the values of the coefficients of the aberration matrices as a function of the positions (X,Y) in the image sensor field, such as:

$$MA ( X , Y ) = {\sum }_{l} α {A}_{l} ( X , Y ) F {A}_{l} ( X , Y ) + E ( X , Y ) ,$$

where
I scans the function basis FA, where 1≤IL, and L≥1.
the term E (X,Y) models the differences between the combination of the FAᵢ and MA functions.

The base FA can preferably be chosen to be sufficiently broad for the term E(X,Y) to have a negligible or even zero effect. These functions can be orthogonal to each other in the sense of a scalar product, but not necessarily. For example, the function basis FAᵢ can be the function basis of Zernike polynomials. To obtain the functions αAᵢ(X,Y), it is sufficient to use a method known from the prior art such as a projection of MA(X, Y) onto FAᵢ (X, Y), in the sense of a scalar product, and to apply the appropriate matrix product to take account of their non-orthogonality, if necessary, to obtain the functions αAᵢ(X,Y). Establishing an aberration kernel precursor (AKP) comes down to finding a parametric model of the functions αA(X,Y), such that for example a polynomial expression represents αAᵢ(X,Y), for example, if I ε{1, 2}, such that αA₁(X,Y)=a₀₁. ((X−x₀₁)²+(Y−y₀₁)²) and αA₂(X,Y)=a₀₂. ((X−x₀₂) (Y−y₀₂))+Z₀₂. The model representing αAᵢ(X, Y), here αA₁(X,Y) and αA₂(X,Y), is then the table of values ((a₀₁, x₀₁, y₀₁); (a₀₂, x₀₂, y₀₂, z₀₂)) in this example. This set of coefficients can be called the aberration kernel precursor, or AKP, matrix (here, this can be a matrix of 1 row×7 columns, or 2 rows by 4 columns with a zero coefficient added to the 1st row). As the functions FAᵢ ( ) are chosen to best model the modes of the aberrations obtained, the parametric model representing the αAI(X,Y) functions depending on the geometric parameters contains significantly fewer coefficients than the numerical representation of the FAᵢ(X, Y) functions. Here, for example, it contains 8 coefficients instead of the 16 million coefficients that would have been needed to represent the aberration functions represented by 4×4 coefficients on an X, Y field of 1000×1000 positions. A final step in obtaining the aberration matrix is to represent the evolution of AKP coefficients as a function of the parameters that are the lens-to-sensor distance LSD and object distance OD, which once again involves a set of several parameters in functions modeling AKP values depending on LSD and OD. It is this last set of coefficients that can advantageously constitute the aberration kernel matrix.

In another example, the kernel aberration matrix can be a table of matrices containing AKP coefficients, or directly the AKP for several sets of LSD and OD parameters. The key is to be able to retrieve the lens aberration matrices from the geometric parameters, preferably by storing less data than the aberration matrices represent.

The aberration kernel matrix can be determined inside the image capturing apparatus, or outside the image capturing apparatus.

For example, the function basis FAᵢ can be the function basis of Zernike polynomials.

At least one correction matrix can be calculated from at least one previously calculated correction kernel matrix, comprising coefficients for deriving said at least one correction matrix.

The use of a correction kernel matrix avoids the need to store all the correction matrices used to correct each image captured during each iteration of the correction phase, and therefore reduces the memory space used to store the correction matrices.

The correction kernel matrix can be determined as follows. Multiple correction matrices can be determined from multiple aberration matrices or from an aberration kernel matrix. Then, from these correction matrices, a common correction matrix, denoted MC, can be identified. This common correction matrix can be stored instead of the multitude of correction matrices, in association with one or more relations, to enable the calculation of each correction matrix.

The correction kernel matrix can be determined in a similar way to that described above for the aberration kernel matrix, using the same function basis FAᵢ, or another suitable function basis.

The correction kernel matrix can be determined inside the image capturing apparatus or outside the image capturing apparatus.

Prior to the first iteration of the acquisition phase, the method according to the invention may also comprise a characterization phase comprising a determination of the at least one, and in particular each, aberration matrix.

The characterization phase can generally be carried out away from the image acquisition apparatus. In this case, the characterization phase is carried out with the optical lens, or the image sensor, not yet mounted in the camera.

Of course, according to alternative embodiments, the characterization phase can also be carried out within the apparatus, in particular with the optical lens, or image sensor, mounted in the apparatus.

The characterization phase may comprise determining:
multiple aberration matrices for different regions Rᵢ of the image sensor;
multiple aberration matrices for multiple LSDᵢ distance values; and/or
multiple matrices for multiple ODⱼ distance values.

In fact, one aberration matrix MA can be determined for the entire image sensor. Alternatively, aberration matrices MAᵢ can be determined, each for a region Rᵢ of the image sensor, with i=1, . . . , I and 1≥2.

Alternatively, or in addition, aberration matrices MAⱼ can be determined, each for a lens-sensor distance LSDᵢ, where j=1, . . . ,J and J≥2.

Alternatively, or in addition, aberration matrices MAₖ can be determined, each for an object distance ODₖ, where k=1, . . . , K and K≥2.

In a non-limiting combination, a plurality of aberration matrices MAᵢⱼₖ can be determined, each for a region Rᵢ, a distance LSDⱼ, and an object distance ODₖ in said region Rᵢ.

According to a further non-limiting combination, multiple aberration matrices MAᵢₖ can be determined, each for a region Rᵢ and an object distance ODₖ in said region Rᵢ. In this case, the aberration matrix, and therefore the image correction, does not take into account the lens-sensor distance LSD.

According to some embodiments, at least one aberration matrix may be determined by optical measurement, on the actual optical lens, with an optical measuring apparatus.

The optical measurement device may include an MTF (Modulation Transfer Function) measuring apparatus, an OTF (Optical Transfer Function) measuring apparatus, or a PSF (Point Spread Function) measuring apparatus, or a wavefront measuring apparatus. Such devices are well known to the person skilled in the art and will not be described in greater detail here for the sake of brevity. They typically comprise a light source, a test pattern, one or more image sensors and a calculating unit.

Alternatively, or in addition, at least one aberration matrix may be determined by simulation in a digital simulator on a digital model of the optical lens.

In this case, the optical lens and image sensor are modeled in software, such as ZEMAX® software, wherein MTF, OTF or PSF functions, or wavefront functions, can be simulated by simulating the emission and propagation of a test light beam and measuring the illumination received on the image sensor.

Regardless of the embodiment, by measurement on the optical lens or by simulation on a digital model of the optical lens, an aberration matrix can be determined as follows.

The optical lens associated with the image sensor is illuminated by a test light beam, then the illumination received at the image sensor is measured. This illumination received by the sensor comprises information on the optical aberrations introduced by the optical lens in each image captured.

The aberration matrix can be obtained for each region of the image sensor, each corresponding to one or multiple pixels on said image sensor. In this case, an illumination pattern is presented in front of the optical lens, such as a checkerboard pattern alternating white and black patterns, and the illumination received at the sensor is measured. This illumination received by the sensor comprises information on the optical aberrations introduced by the optical lens in each image captured.

A transformation of the captured images may be necessary in order to obtain, for example, the point spread function (PSF) which would correspond to, for example, a test beam originating from a single point of light illuminating the lens, moved into multiple regions of the field visible through the lens in order to obtain the PSFs for multiple regions of the sensor. But although the measurement, or simulation, allows the optical lens to be illuminated from a single movable point, these transformations can generally be omitted.

In non-limiting embodiments, at least one, in particular each, aberration matrix may be:
a PSF matrix, of Point Spread Function (PSF) values, and/or
an OTF matrix, of Optical Transfer Function (OTF) values, and/or
a matrix of values obtained by wavefront analysis.

Of course, other types of aberration matrix can be used, and the invention is not limited to any particular type of aberration matrix.

The method according to the invention may comprise a step for calculating a matrix, called aberration kernel matrix, comprising coefficients enabling at least one aberration matrix to be deduced.

The aberration kernel matrix can be determined as described above, inside or outside the device capturing the image to be corrected.

The method according to the invention may further comprise a step for calculating a matrix, called correction kernel matrix, comprising coefficients enabling at least one correction matrix to be deduced.

The correction kernel matrix can be determined as described above, inside or outside the device capturing the image to be corrected.

According to another aspect of the present invention, an image acquisition system is proposed with an apparatus comprising a camera module having an optical lens associated with an image sensor, said system comprising:
a device for characterizing said optical lens to determine at least one matrix, called aberration matrix, representative of optical aberrations introduced by said optical lens into an image captured by said camera module,
said camera module for capturing an image, and
a calculating unit in said apparatus;
configured to implement the image acquisition method according to the invention.

The system according to the invention may comprise, in terms of hardware and/or software, any combination of the features described above with reference to the method according to the invention and which are not mentioned herein for the sake of brevity.

The characterization device may comprise an optical measuring apparatus for measuring at least one aberration matrix on the actual optical lens. Alternatively, the characterization device may comprise a digital simulator for determining at least one aberration matrix by simulating a digital model of the optical lens.

The calculating unit can be a processor, a calculator or any programmable electronic chip. The calculating unit can be a processor or a graphics card of the apparatus capturing the image.

According to another aspect of the present invention, an image acquisition apparatus is proposed, comprising:
a camera module comprising an optical lens associated with an image sensor, and
a calculating unit;
configured to implement the steps of the image acquisition method according to the invention.

The apparatus according to the invention may comprise, in terms of hardware and/or software, any combination of the features described above with reference to the method according to the invention and which are not mentioned herein for the sake of brevity.

According to non-limiting examples, the apparatus according to the invention can be a camera, a smartphone, a tablet, a computer, a webcam, etc.

### DESCRIPTION OF THE FIGURES AND EMBODIMENTS

Other benefits and features shall become evident upon examining the detailed description of entirely non-limiting embodiments, and from the appended drawings in which:

FIG. 1 is a schematic representation of a non-limiting exemplary embodiment of an optical element that may be used in an optical lens within the meaning of the present invention;

FIG. 2 is a schematic depiction of a non-limiting exemplary embodiment of a camera module within the meaning of the present invention;

FIG. 3 is a schematic depiction of a non-limiting exemplary embodiment of a characterization phase that can be implemented in a method according to the present invention;

FIGS. 4, 5a, 5b and 5c are schematic representations of non-limiting exemplary embodiments of an image acquisition method according to the invention;

FIG. 6 is a schematic representation of a non-limiting exemplary embodiment of a device for characterizing an optical lens;

FIG. 7 is a schematic representation of a non-limiting exemplary embodiment of an image acquisition apparatus according to the invention; and

FIG. 8 is a schematic representation of a non-limiting exemplary embodiment of an image acquisition apparatus according to the invention.

It is clearly understood that the embodiments that will be described hereafter are by no means limiting. In particular, it is possible to imagine variants of the invention that comprise only a selection of the features disclosed hereinafter in isolation from the other features disclosed, if this selection of features is sufficient to confer a technical benefit or to differentiate the invention with respect to the prior art. This selection comprises at least one preferably functional feature which is free of structural details, or only has a portion of the structural details if this portion alone is sufficient to confer a technical benefit or to differentiate the invention with respect to the prior art.

In particular, all of the described variants and embodiments can be combined with each other if there is no technical obstacle to this combination.

In the figures and in the remainder of the description, the same reference has been used for the features that are common to several figures.

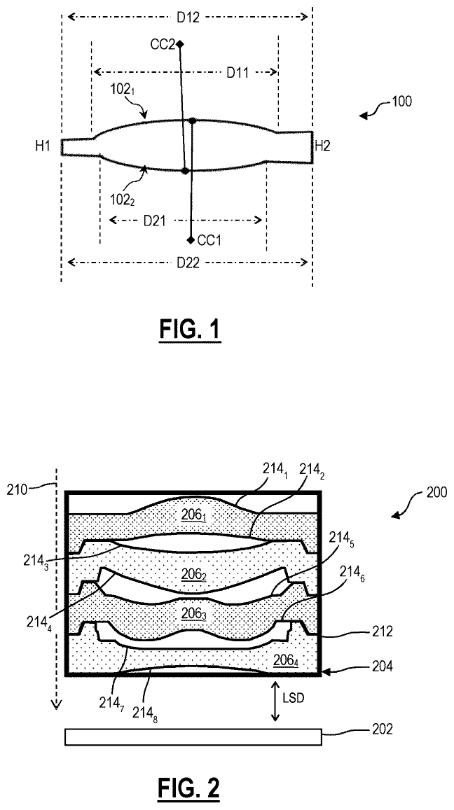

FIG. 1 is a schematic representation of a non-limiting exemplary embodiment of an optical element that can be used to manufacture an optical lens.

The optical element 100 of FIG. 1 can be used with at least one other optical element to manufacture an optical lens. An example of an optical lens, given as a non-limiting example, will be described with reference to FIG. 2.

The optical element 100 can be a lens element, a blade, etc. In the following, and without loss of generality, the optical element is assumed to be a lens element.

The optical lens element 100 can, for example, be manufactured by injection molding. An injection molding method generally follows the following sequence of steps:
polymer injection and mold filling,
pressurization,
maintaining pressure,
cooling, and
removal from the mold.

Injection-based lens manufacturing methods, although common, can fluctuate and generate errors in the characteristic parameters of the lens, particularly with regard to its geometry.

The lens element 100 has a given geometric shape. It has two interfaces 102₁ and 102₂, each with a given geometric shape. Thus, the geometric shape of lens element 100 is determined by:
a geometrical shape of each of the optical interfaces 102₁ and 102₂;
a center of curvature, denoted CC1 and CC2, of each of the optical interfaces 102₁ and 102₂;
an apex position, denoted A₁ and A₂, of each of the optical interfaces 102₁ and 102₂;
at least one thickness, denoted H1 and H2, of the lens element 100 along its periphery;
an inside diameter, denoted D11 and D21 respectively, and/or an outside diameter, denoted D12 and D22 respectively, of each of the interfaces 102₁ and 102₂;
a concentricity or eccentricity value for interfaces 102₁ and 102₂
a surface roughness of each of the optical interfaces 102₁ and 102₂;
etc.

The value of at least one of these geometric parameters can be supplied by the manufacturer. Alternatively, or additionally, the value of at least one geometric parameter can be measured, for example by optical or mechanical profilometry. Alternatively, or additionally, the value of at least one geometric parameter can be determined by simulation, using digital modeling of the lens element 100. Alternatively, or additionally, the value of at least one geometric parameter can be measured, for example by optical interferometry.

In addition, the lens element 100 has optical characteristics since it is an optical element. It is therefore characterized by at least one optical parameter such as:
a refraction index, denoted 11 and 12, of each of the optical interfaces 102₁ and 102₂;
an Abbe number, denoted Ab,
etc.

Any combination of these individual parameters, and in particular all of them, can be used to digitally model the optical element 100.

FIG. 2 is a schematic representation of a non-limiting exemplary embodiment of a camera module comprising an optical lens and an image sensor in the sense of the present invention.

The camera module 200 comprises an image sensor 202. The image sensor can be any type of photosensitive sensor, such as a CMOS sensor (known as the “CMOS Imager System”, which goes by the acronym CIS), or a CCD sensor.

The camera module 200 further comprises an optical lens 204. The function of the optical lens 204 is to focus an image of a scene in an image plane, that is, the plane of the image sensor 202.

An optical lens 204 is generally made up of a stack of optical elements comprising any combination of optical elements such as lens elements, spacers, and opacifiers, etc.

During manufacture of the optical lens, each optical element of said lens is individually selected and stacked with the other optical elements in an assembly barrel, in a given order. The stack is then secured to the barrel using known techniques, such as gluing.

In FIG. 2, and by way of non-limiting example only, the optical lens element 204 comprises four lens elements 206₁-206₄ stacked, in a stacking direction 210, also known as the Z axis, in a barrel 212. At least two of the lens elements 206₁-206₄ can be separated from each other by an air gap or spacer.

At least one of the lens elements 206₁-206₄ may, for example, be the lens element 100 shown in FIG. 1.

Each of the lens elements 206₁-206₄ has two interfaces, an upstream interface and a downstream interface, in the direction of the stack 210. Thus, lens element 206₁ has an upstream interface 214₁ and a downstream interface 214₂, lens element 206₂ has an upstream interface 214₃ and a downstream interface 214₄, lens element 206₃ has an upstream interface 214₅ and a downstream interface 214₆ and lens element 208₄ has an upstream interface 214₇ and a downstream interface 214₈.

Thus, for the optical lens 204 of FIG. 2, and in general for any optical lens comprising a stack of optical elements, it is possible to determine a set of data, called a geometric set, hereinafter referred to as JG, comprising data relating to at least one geometric parameter of at least one, and in particular of each, optical interface 206₁ of said stack.

Such a geometric set JG may include data relating to, or values of, any of the following geometric parameters:
at least one position of at least one optical interface 206₁-206₄ of the lens 204 along the Z-axis;
at least one decentration value of at least one optical interface 206₁-206₄ relative to the Z axis, or relative to a center position of another interface, in the X-Y plane; or
at least one inclination value of at least one optical interface 206₁-206₄ relative to the Z axis, or relative to the inclination of another interface;
at least one topography or shape profile value of at least one optical interface 206₁-206₄.

Generally speaking, the geometric set JG may comprise, for each optical interface of the optical lens 204, M geometric parameters with M≥1 and preferentially M≥2. If the optical lens 204 comprises N optical elements, each optical element having two interfaces, then the geometric set JG may comprise 2N×M parameters and can correspond to a matrix with 2N rows and M columns. Of course, the geometric set JG may comprise the same number of geometric parameters for at least two optical interfaces, or different numbers of geometric parameters for at least two optical interfaces.

The geometric set JG may directly comprise the values of the geometric parameters. These values can be measured by optical interferometry or confocal measurement(s), preferentially from one side or face of the optical lens 204, so as to avoid turning it.

The geometric set of the optical lens 204, optionally together with the individual parameters of each optical element, such as any combination of the parameters described with reference to FIG. 1, can be used to digitally model the camera module in a digital simulator, such as, for example, and without loss of generality, the commercially available “ZEMAX®” simulator.

Optionally, the distance, LSD, between the optical lens 204 and the image sensor 202 can be changed, for example by a focus or zoom modification mechanism. The value of this LSD distance can be measured by a sensor provided for this purpose, or can be supplied by the zoom mechanism, or from a configuration of said zoom mechanism.

Furthermore, the distance OD between the optical lens and the scene being imaged generally varies from one image to the next. What's more, within the same image, objects in the scene may be at different distances from the optical lens. For a given image, this OD distance, and possibly OD distances for different regions of the optical sensor, can be determined either by analysis of the captured image, or by one or more sensors, such as LIDAR sensors.

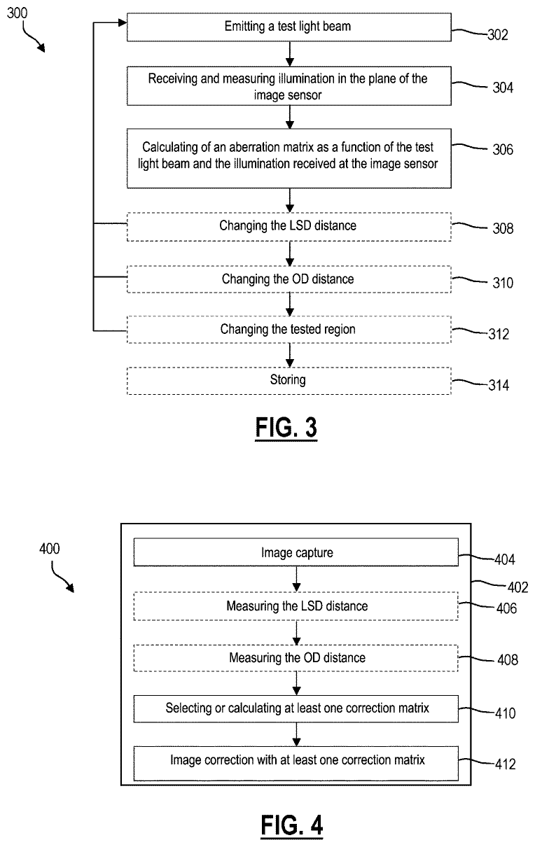

FIG. 3 is a schematic depiction of a non-limiting exemplary embodiment of a characterization phase that can be implemented in a method according to the present invention.

Phase 300 of FIG. 3 is used to determine one or more aberration matrices, representative of the optical aberrations introduced into an image taken by an optical lens, and in particular by the optical lens 200 of FIG. 2.

The characterization phase 300 can be carried out outside the image acquisition apparatus, that is, before the optical lens or camera module is mounted in the image acquisition apparatus. Alternatively, the characterization phase 300 can be implemented in the image acquisition apparatus, after the optical lens, or camera module, has been mounted in the image acquisition apparatus. In this case, some or all of the steps in the characterization phase are implemented in said image acquisition apparatus.

Phase 300 comprises a step 302 of emitting a test light beam towards the optical lens, and in particular towards the camera module comprising the optical lens and the image sensor. The test light beam can be described by a matrix of values, denoted MT.

The test light beam passes through the optical lens and is received by the image sensor. The illumination that passed through the optical lens is measured by the optical sensor in step 304. This illumination received by the sensor comprises information on the optical aberrations introduced by the optical lens in each image captured. The illumination observed and measured at the image sensor can be described by a matrix of values, denoted MTOBS.

Knowing the matrix MT and measuring the MTOBS matrix, it is possible to determine, in a step 306, an aberration matrix, MA, as a convolution of the matrices between MT and MA, such that

$$MTOBS = MT * MA$$

Optionally, but particularly advantageously, the aberration matrix may be obtained, individually for different distances LSDⱼ between the optical lens and image sensor, where j=1, . . . , J and J≥2. In this case, in a step 308, the LSD distance is modified, for example by moving the image sensor closer to or further away from the optical lens, and steps 302-306 are repeated for each distance LSDⱼ.

Optionally, but particularly advantageously, the aberration matrix can be obtained, individually for different distances ODⱼ between the optical lens and the scene, where k=1, . . . , K and K≥2. In this case, in a step 310, the OD distance is modified, for example by moving the source of the test light beam closer to or further away from the optical lens, and steps 302-308 are repeated for each distance ODⱼ.

The aberration matrix may be obtained in a single operation for the entire expanse of the image sensor.

Alternatively, the aberration matrix may be obtained, individually for different regions of the image sensor, Rᵢ where i=1, . . . ,l and I≥2, each corresponding to one or more pixels on said image sensor, in the plane of the image sensor. In this case, in a step 312, the test region is modified and steps 302-310 are repeated for each region Rᵢ individually.

In this way, the characterization phase 300 provides at least one aberration matrix MA. In the following, and without loss of generality, it is considered that the characterization phase 300 provides a number NB=|×J×K of aberration matrices MAᵢⱼₖ for different regions Rᵢ, different distances LSDⱼ and different distances ODₖ.

In an optional step 314, the aberration matrices can be stored in a database.

Phase 300 of FIG. 3 can be part of an image acquisition method according to the invention, such as the examples that will be described later. However, the image acquisition method described in the invention does not necessarily comprise such a characterization phase.

At least one aberration matrix may be determined by optical measurement on the actual optical lens with an optical measurement device comprising an optical beam source, and optionally a calculating unit. The optical measuring apparatus may comprise an MTF (Modulation Transfer Function) measuring apparatus, or an OTF (Optical Transfer Function), or a PSF (Point Spread Function) measuring apparatus. Such apparatuses are well known to the person skilled in the art.

Alternatively, at least one aberration matrix may be determined by simulation in a digital simulator on a digital model of the optical lens. A digital model of the optical lens can be defined in a simulator, for example from any combination of the geometric parameters described with reference to FIG. 2 and/or individual parameters described with reference to FIG. 1. In this case, the optical lens and image sensor are modeled in software, such as ZEMAX® software, wherein MTF, OTF or PSF functions can be simulated by simulating the emission and propagation of a test light beam and measuring the illumination received on the image sensor.

FIG. 4 is a schematic representation of a non-limiting exemplary embodiment of an image acquisition method according to the invention.

The method 400 of FIG. 4 comprises at least one iteration of an image acquisition phase 402 with a camera module, and in particular with the camera module 200 of FIG. 2.

Phase 402 comprises an image capture step 404. The captured image is in the form of a matrix of values, supplied by the image sensor and denoted IMₐ. The matrix IMₐ comprises numerical values for each sensor pixel. For example, for an RGB image, the matrix IMₐ contains three values for each pixel, one for each color. The acquired image, and therefore the matrix IMₐ, comprises optical aberrations introduced by the optical lens, such as optical blurring or displacement.

Optionally, but particularly advantageously, the acquisition phase 402 may comprise a step 406 for determining, by measurement or calculation, the LSD distance between the optical lens and the image sensor, during image acquisition. The captured image can then be corrected by selecting, or calculating, the correction matrix corresponding to said LSD distance.

Optionally, but particularly advantageously, the acquisition phase 402 may comprise a step 408 for determining, by measurement or calculation, at least one OD distance between the optical lens and the imaged scene, during image acquisition. In particular, an OD distance can be measured/calculated for each region Rᵢ of the image sensor. Correction of the captured image can then be performed by selecting, or calculating, the correction matrix(es) corresponding to said OD distance(s) for each region Rᵢ.

In a step 410, at least one correction matrix is optionally selected or calculated as a function of the LSD and/or OD distances determined in optional steps 406 and 408. When the, or each, correction matrix is previously calculated and stored in a database, then step 410 performs merely a selection of the, or each, correction matrix from said database. When the, or each, correction matrix has not been previously calculated, then step 410 performs an on-the-fly calculation of the, or each, correction matrix.

The captured image, and in particular the matrix IMₐ representing the captured image, is corrected, in part or in full, in a step 412. To do this, at least some of the values of the matrix IMₐ are corrected using at least one correction matrix selected/calculated in step 410. In the following, and without loss of generality, it is assumed that a correction matrix, denoted MCᵢⱼₖ, is used for each region Rᵢ of the sensor, for the distance LSDⱼ determined in step 406, and for the distance ODₖ determined in step 408 for said region Rᵢ. Referring to the matrix representing the corrected image as IM_{c}, the image correction can be performed by convolving the matrix IMₐ with each correction matrix MCᵢⱼₖ, for each region Rᵢ of the image sensor:
IM_{c}=IMₐ*MCᵢⱼₖ, where i=1, . . . , I and 1≥2

In the corrected image thus obtained, the aberrations introduced by the optical lens are corrected, or at least mitigated.

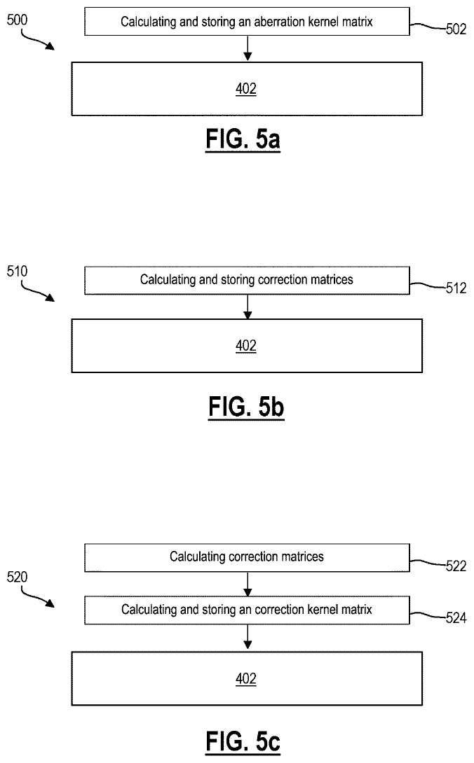

FIG. 5a is a schematic depiction of another non-limiting exemplary embodiment of a method according to the invention.

The method 500 of FIG. 5a comprises the acquisition phase 402 of method 400 of FIG. 4.

Before the acquisition phase 402, the method 500 further comprises a step 502 for calculating an aberration kernel matrix from the aberration matrices determined for the optical lens. Indeed, in order to reduce the storage resources required to store aberration matrices, it may be advantageous to calculate an aberration kernel matrix which will then be used to calculate, on-the-fly, the aberration matrix for each region Rᵢ of the image sensor, optionally as a function of the LSD distance and/or the OD distance(s) measured for each captured image.

In this case, in step 410, each aberration matrix MAᵢⱼₖ for each region Rᵢ is deduced, on the fly, from the kernel aberration matrix. Then, each MAᵢⱼₖ aberration matrix is used to calculate the MCᵢⱼₖ correction matrix for each Rᵢ region of the image sensor.

The aberration kernel matrix can be determined as described above, using a function basis.

FIG. 5b is a schematic depiction of another non-limiting exemplary embodiment of a method according to the invention.

The method 510 of FIG. 5b comprises the acquisition phase 402 of method 400 of FIG. 4.

The method 510 further comprises, prior to the acquisition phase 402, a step 512 for calculating and storing all the correction matrices MCᵢⱼₖ that can potentially be used to correct an image during the acquisition phase. In other words, step 512 calculates, for each region Rᵢ, and possibly for each distance LSDⱼ and/or each distance ODₖ, a correction matrix MCᵢⱼₖ from the aberration matrix MAᵢⱼₖ determined during the characterization phase. Each of these correction matrices MCᵢⱼₖ is then stored in a database.

In this case, the step 410 of acquisition phase 402 does not perform any correction matrix calculation. During this step 410, the database storing the correction matrices MCᵢⱼₖ is read to select, for each region Rᵢ of the sensor, the desired correction matrix for correcting the acquired image, possibly for the distance LSDⱼ and/or the distance ODₖ measured for said region Rᵢ.

FIG. 5c is a schematic depiction of another non-limiting exemplary embodiment of a method according to the invention.

The method 520 of FIG. 5c comprises the acquisition phase 402 of the method 400 of FIG. 4.

The method 520 further comprises, prior to the acquisition phase 402, a step 522 for calculating the correction matrices MCᵢⱼₖ that can potentially be used to correct an image during the acquisition phase 402. In other words, step 522 calculates, for each region Rᵢ, and possibly for each distance LSDⱼ and/or each distance ODₖ, a correction matrix MCᵢⱼₖ from the aberration matrix MAᵢⱼₖ determined during the characterization phase.

Also before the acquisition phase 402, method 520 further comprises a step 524 for calculating a correction kernel matrix from the correction matrices MCᵢⱼₖ determined for the optical lens in step 522. Indeed, in order to reduce the storage resources required to store all the correction matrices MCᵢⱼₖ, it may be advantageous to calculate a correction kernel matrix that will be used to calculate, on the fly, each correction matrix MCᵢⱼₖ for each region Rᵢ of the image sensor, optionally as a function of the LSD distance and/or the OD distance(s) measured for each image captured during the acquisition phase 402.

In this case, in step 410 of the acquisition phase, each correction matrix for each region Rᵢ is deduced, on the fly, from the correction kernel matrix, and optionally as a function of the LSD distance and/or the measured OD distance(s).

The correction kernel matrix can be determined as described above, using a function basis.

In the examples described with reference to FIGS. 5a, 5b and 5c, each of steps 502, 512, 522 and 524 can be implemented either in the imaging apparatus performing the image capture, that is, the apparatus equipped with the camera module, or outside said imaging apparatus.

For example, in the method 500 of FIG. 5a, the step 502 for calculating the aberration kernel matrix can be performed in the imaging apparatus, or outside the imaging apparatus, for example in an optical lens characterization device, for example one implementing the characterization phase 300 of FIG. 3.

In the method 510 of FIG. 5b, the step 512 for calculating the correction matrices can be performed in the imaging apparatus, or outside the imaging apparatus, for example in an optical lens characterization device, for example one implementing the characterization phase 300 of FIG. 3.

In the method 520 of FIG. 5c, the step 522 for calculating the correction matrices, respectively the step 524 for calculating the correction kernel matrix, can be performed in the imaging apparatus, or outside the imaging apparatus, for example in an optical lens characterization device, for example one implementing the characterization phase 300 of FIG. 3.

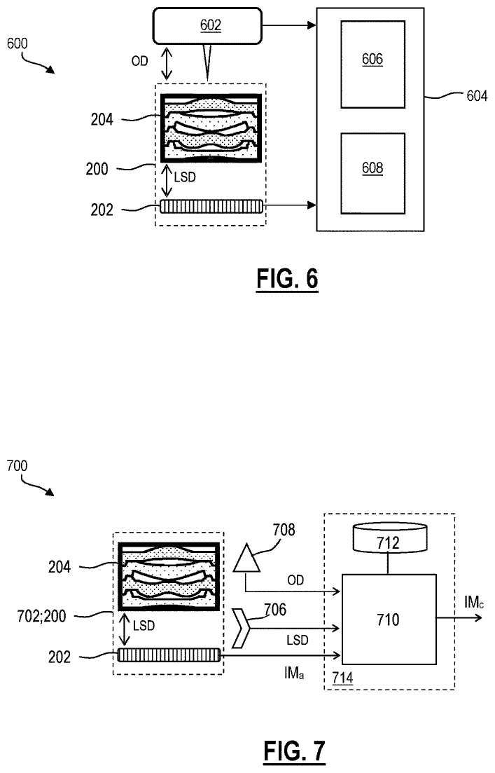

FIG. 6 is a schematic representation of a non-limiting exemplary embodiment of a device for characterizing an optical lens.

The device 600 of FIG. 6 can be used to characterize any type of optical lens used for acquiring images, and in particular the lens 200 of FIG. 2.

The device 600 of FIG. 6 can be used to implement a characterization phase of an optical lens, and in particular the characterization phase 300 of FIG. 3, in order to determine, at least, aberration matrices representative of the aberrations introduced by an optical lens in an image captured with said optical lens.

The device 600 comprises a source 602 for emitting one or more test light beams in the direction of the optical lens, and in particular in the direction of the camera module, such as the camera module 200 of FIG. 2.

The device 600 may include a mechanism (not shown) for adjusting the position of the source 602:
in the Z direction of emission of the test light beam, so as to adjust the OD distance and determine aberration matrices for different OD distances, and/or
in the plane, denoted X-Y, perpendicular to the Z direction of emission of the test light beam, to modify the region Rᵢ for which an aberration matrix is determined.

The device 600 may comprise a mechanism (not shown) for adjusting the relative positions of the optical lens and the image sensor in the Z direction, so as to adjust the LSD distance between the image sensor and the optical lens and determine aberration matrices for different LSD distances.

The device 600 may comprise a calculating unit 604.

This calculating unit 604 is designed to receive a matrix of values, denoted MT, representing the test light beam emitted by the source 602, and a matrix of values, denoted MTOBS, representing the illumination observed by the image sensor for this test light beam.

The calculating unit 604 may comprise a calculation module 606 designed to calculate, as a function of the MT and MTOBS matrices, an aberration matrix, denoted MA, for example using the following convolution relationship:

$$MTOBS = MT * MA$$

When the aberration matrix is determined for a region Rᵢ, a distance LSDⱼ, and a distance ODₖ for this region Rᵢ, the relationship used can be denoted as follows:

$$M T O B {S}_{i j k} = M {T}_{ijk} * {MA}_{i j k}$$

The calculating unit 604 may further comprise a calculating module 608 designed to calculate an aberration kernel matrix, for example by implementing step 502 of method 500, in which case this step 502 is not implemented in the imaging apparatus.

Alternatively, or additionally, the calculating module 608 may be provided to calculate:
at least one correction matrix, for example by implementing step 512 of the method 510, or step 522 of the method 520, in which case this step is not implemented in the imaging apparatus; and
optionally, at least one correction kernel matrix, for example by implementing step 524 of the method 520, in which case this step is not implemented in the imaging apparatus.

The calculating unit 604 may be in hardware form, such as a server, a computer, a processor, an electronic chip, etc. Alternatively, the calculating unit 604 may be in software form, such as one or more computer programs. According to yet another alternative, the calculating unit 604 may be formed by any combination of at least one hardware means and at least one software means.

The modules 606 and 608 may each be an individual module, independent of the other. Alternatively, the modules 606 and 608 may be integrated into a single module. Each of the modules 606 and 608 may be in hardware form, such as a server, a computer, a processor, an electronic chip and so on. Alternatively, each of the modules 606 and 608 may be in software form, such as a virtual machine, one or more computer programs, etc. According to yet another alternative, each of the modules 606 and 608 may be formed by any combination of at least one hardware means and at least one software means.

FIG. 7 is a schematic representation of a non-limiting exemplary embodiment of an image acquisition apparatus according to the invention.

The device 700 of FIG. 7 may be used to implement a method for acquiring an image according to the invention, and in particular any one of the methods 400, 500, 510 or 520 of FIGS. 4, 5a, 5b, and 5c.

The device 700 comprises a camera module 702, which may for example be the camera module 200 of FIG. 2, comprising an image sensor, for example an image sensor 202, and an optical lens, for example optical lens 204.

Optionally, the device 700 may comprise a sensor 706 designed to measure the LSD distance between the optical lens 704 and the image sensor 702. Such a sensor 706 can be a capacitive sensor, a resistive sensor, or an optical sensor. This sensor 706 provides a value of the LSD distance, or a value of an electrical quantity representative of the LSD distance, such as a voltage, a current, etc.

Optionally, the device 700 may comprise a sensor 708 designed to measure the OD distance between the optical lens 204 and the imaged scene. Such a sensor 708 may be a LIDAR sensor, for example. This sensor 708 provides a value of the distance OD, or a value of an electrical quantity representative of this distance OD, such as for example a voltage, a current, etc. Preferentially, but by no means restrictively, this sensor 708 is designed to measure the distance OD individually for different regions Rᵢ of the image sensor 202.

The device 700 further comprises a calculating unit 710 configured to correct the image captured by the sensor 704, and in particular the matrix IMₐ representing the captured image and provide a matrix, denoted IM_{c}, representing the corrected image, based on at least one correction matrix MCᵢⱼₖ.

The calculating unit 710 can be a hardware unit such as a processor or a computer chip. Alternatively, the calculating unit can be a computer program or application.

According to some embodiments, the at least one correction matrix MCᵢⱼₖ may be read from a memory area, or database, 712. In this case, the calculating unit 710 reads said at least one correction matrix, optionally based on the LSD and/or OD distances measured during image capture.

According to some embodiments, the calculating unit 710 may be further configured to calculate, in particular on the fly, the at least one correction matrix, as a function of:
a correction kernel matrix.
at least one predetermined aberration matrix, or
an aberration kernel matrix;

stored in the database 712. In this case, the calculating unit reads said at least one matrix and calculates the at least one correction matrix from said at least one matrix that was read.

In the example shown, the camera module 702 comprises the optical lens 204 and the image sensor 202, and optionally distance sensors 706 and 708. The camera module 702 may comprise components other than those shown, such as a focus adjustment mechanism (not shown) that modifies the distance between the image sensor 704 and the optical lens 702.

The calculating unit 710, and optionally the database 712, may be integrated into a photo and/or video app, 714, installed or executed within an apparatus such as a smartphone, tablet, computer, etc.

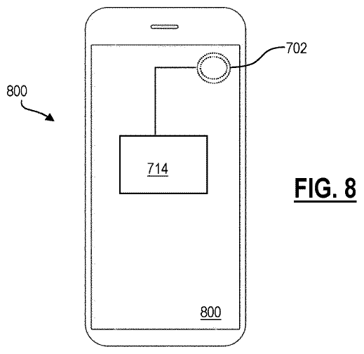

FIG. 8 is a schematic representation of a non-limiting exemplary embodiment of an image acquisition apparatus according to the invention.

The apparatus 800 may comprise all the elements of the apparatus 700 shown in FIG. 7.

According to embodiments, the apparatus 800 can be a still camera, a tablet or smartphone, a computer, a surveillance camera, and more generally a camera module for integration into another device, etc.

In the example shown, the apparatus 800 is a smartphone comprising a display screen 802 provided on its front face and the camera module 702 opening onto its rear face, the app 714 integrating the calculating unit 710 and the database 712.

Of course, the invention is not limited to the examples disclosed above.

1. A method for image acquisition with an apparatus including a camera module having an optical lens associated with an image sensor, said method including at least one iteration of a phase of image acquisition by said apparatus comprising the following steps:
capturing an image with said camera module; and
correcting said captured image as a function of at least one correction matrix calculated, directly or indirectly, from at least one matrix, called aberration matrix, determined for said optical lens, and representative of optical aberrations introduced by said optical lens into an image.

2. The method according to claim 1, characterized in that the image acquisition phase comprises a step of determining a distance, LSD, between the optical lens and the image sensor, the at least one correction matrix being a function of said LSD distance.

3. The method according to claim 1, characterized in that the image acquisition phase further comprises a step of determining a distance, OD, between the optical lens and the scene, the at least one correction matrix being a function of said OD distance.

4. The method according to claim 1, characterized in that it comprises a step of calculating at least one correction matrix within said apparatus.

5. The method according to claim 4, characterized in that the step of calculating the at least one correction matrix is carried out during the acquisition phase so that said at least one correction matrix is calculated on the fly for each captured image.

6. The method according to claim 1, characterized in that the step of calculating the at least one correction matrix is performed prior to the acquisition phase so that said calculating step is common to multiple iterations of the image acquisition phase.

7. The method according to claim 4, characterized in that at least one correction matrix is calculated from:
at least one aberration matrix;
at least one previously calculated correction kernel matrix comprising coefficients for deducing said at least one correction matrix; or
at least one previously calculated aberration kernel matrix, comprising coefficients enabling said at least one correction matrix to be deduced.

8. The method according to claim 1, characterized in that it further comprises, prior to the first iteration of the acquisition phase, a characterization phase comprising a determination of at least one aberration matrix.

9. The method according to claim 1, characterized in that the characterization phase comprises determining:
multiple aberration matrices for multiple regions of the image sensor;
multiple aberration matrices for multiple LSD distance values; and/or
multiple aberration matrices for multiple OD distance values.

10. The method according to claim 8, characterized in that said at least one aberration matrix is determined by optical measurement, on the actual optical lens, with an optical measuring apparatus.

11. The method according to claim 8, characterized in that said at least one aberration matrix is determined by simulation in a digital simulator on a digital model of the optical lens.

12. The method according to claim 8, characterized in that said at least one aberration matrix is:
a matrix, called PSF matrix, of Point Spread Function values, and/or
a matrix, called OTF matrix, of Optical Transfer Function values, and/or
a matrix of values obtained by wavefront analysis.

13. The method according to claim 1, characterized in that it comprises a step of calculating a matrix, called aberration kernel matrix, comprising coefficients enabling at least one aberration matrix to be deduced.

14. An image acquisition system with a device comprising a camera module having an optical lens associated with an image sensor, said system comprising:
a device for characterizing said optical lens to determine at least one matrix, called aberration matrix, representative of optical aberrations introduced by said optical lens into an image captured by said camera module,
said camera module for capturing an image, and; and
a calculating unit in said apparatus;
configured to implement the method according to claim 8.

15. An image acquisition apparatus comprising:
a camera module comprising an optical lens associated with an image sensor, and
a calculating unit;
configured to implement the steps of the method according to claim 1.
